(19) United States
(12) Patent Application Publication
(10) Pub. No.: US 2022/0040553 A1
(43) Pub. Date: Feb. 10, 2022

(54) ELECTRONIC CADDIE-TYPE GOLF ASSISTANCE SYSTEM BASED ON WEATHER INFORMATION CALCULATED BY INPUTTING REAL-TIME WEATHER MEASUREMENTS INTO HIGH-PRECISION WEATHER MODELING

(71) Applicant: WINDWISH CO., LTD., Jeju-do (KR)

(72) Inventor: Jae Chul Lim, Jeju-do (KR)

(21) Appl. No.: 17/310,857

(22) PCT Filed: Oct. 29, 2019
(86) PCT No.: PCT/KR2019/014402

§ 371 Date: Aug. 26, 2021

(30) Foreign Application Priority Data
Feb. 28, 2019 (KR) 10-2019-0023647

(51) Int. Cl. A63B 71/06; G01W 1/04; A63B 69/36

(52) U.S. Cl. CPC A63B 71/0622; G01W 2001/006; A63B 69/3605; G01W 1/04

(57) ABSTRACT

The present invention relates to an electronic caddie-type golf assistance system and, more particularly, to an electronic caddie-type golf assistance system based on weather information calculated by inputting weather measurements into high-precision weather modeling. The golf assistance system according to the present invention comprises: a weather information acquisition device for acquiring weather information of a golf course; a wind information restoration device which models the weather information acquired by the weather information acquisition device to restore wind information; and an electronic caddie device for providing caddie information on the basis of the restored wind information. The golf assistance system according to the present invention may improve golfing performance by providing local-scale 3D wind information of a golf course.

### CROSS-REFERENCE TO RELATED APPLICATION(S)

The present application is a Section 371 National Stage Application of International Application No. PCT/KR2019/014402, filed on Oct. 29, 2019, entitled “ELECTRONIC CADDIE-TYPE GOLF ASSISTANCE SYSTEM BASED ON WEATHER INFORMATION CALCULATED BY INPUTTING REAL-TIME WEATHER MEASUREMENTS INTO HIGH-PRECISION WEATHER MODELING,” which claims priority to Korean Patent Application No. 10-2019-0023647, filed on Feb. 28, 2019, which are incorporated herein by reference in their entirety.

### BACKGROUND

### Field

The present disclosure relates to an electronic caddie-type golf assistance system, and in particular, to an electronic caddie-type golf assistance system based on weather information calculated by inputting weather measurement values into a high-precision weather modeling.

### Description of Related Art

Golf refers to a game in which a ball is hit with a golf club (hereinafter, referred to as a club) and put into a hole in a ground, that is, in a golf course. As described above, the golf is played on the golf course, and a rule is that a person with the fewest strokes until the ball enters the hole wins the game. Therefore, in order to win the game, a player must hit the ball by an accurate driving-distance and in an accurate direction. However, many weather factors such as atmospheric pressure, humidity, and temperature affect the golf game. In this connection, wind has the greatest impact on golf. However, generally, weather information provided by the Korea Meteorological Administration is based on per 1 km. When the information is applied to the golf courses, this is not meaningful wind information. Therefore, a current electronic caddie service only displays a golf course and a remaining distance to the hole but is not based on real-time wind information and thus had limitation in improving golfing performance of the player.

### SUMMARY

A purpose of the present disclosure is to provide an electronic caddie-type golf assistance system which is based on weather information calculated by inputting real-time weather measurement values into a high-precision weather modeling, and which provides wind information to improve golfing performance of the player.

Purposes of the present disclosure are not limited to the above-mentioned purpose. Other purposes and advantages of the present disclosure that are not mentioned above may be understood based on following descriptions, and will be more clearly understood with reference to embodiments of the present disclosure. Further, it will be readily apparent that the purposes and advantages of the present disclosure may be realized using means and combinations thereof indicated in the Claims.

A golf assistance system according to the present disclosure includes a weather measurement value collection device configured to acquire weather information on a golf course; a weather modeling device configured to model the weather information acquired from the weather information acquiring device to recover wind information; and a golf assisting device configured to present caddie information based on the recovered wind information.

The weather information acquiring device includes a plurality of weather information acquiring devices arranged in 8 directions or 4 directions along a perimeter of the golf course.

The golf assisting device includes: a position information creation module configured to create position information; a driving-distance information input module configured to receive club-specific driving-distance information from a user; a club selection module configured to receive a currently-to-be-used club from the user; and a caddie information display module configured to display the caddie information created from the weather modeling device.

The weather modeling device includes a caddie information creation module, wherein the caddie information creation module includes: a driving-distance predicted information creation module configured to create driving-distance predicted information based on a wind direction and a wind speed included in the wind information, and the club-specific driving-distance information received by the driving-distance information input module; and a club selection information creation module configured to select a club corresponding to the driving-distance predicted information created by the driving-distance predicted information creation module to create club selection information.

The caddie information includes wind information created by the weather modeling device, the driving-distance predicted information, and the club selection information.

The golf assistance system according to the present disclosure may provide local-scale three-dimensional wind information on the golf course to improve golfing performance of the player.

The above-described effects, and specific effects of the present disclosure as not mentioned above will be described based on specific details for carrying out the disclosure.

### BRIEF DESCRIPTION OF THE DRAWINGS

FIG. 1 is a block diagram of an electronic caddie-type golf assistance system based on weather information calculated by inputting real-time weather measurement values into a high-precision weather modeling according to the present disclosure.

FIG. 2 is an example of recovered Jejudo wind and precipitation at 1 km resolution in an electronic caddie-type golf assistance system based on weather information calculated by inputting real-time weather measurement values into a high-precision weather modeling according to the present disclosure.

### DETAILED DESCRIPTION

The above objects, features and advantages will be described in detail later with reference to the accompanying drawings. Accordingly, a person with ordinary knowledge in the technical field to which the present disclosure belongs will be able to easily implement the technical idea of the present disclosure. In describing the present disclosure, when it is determined that a detailed description of a known component related to the present disclosure may unnecessarily obscure gist the present disclosure, the detailed description is omitted. Hereinafter, a preferred embodiment according to the present disclosure will be described in detail with reference to the accompanying drawings. In the drawings, the same reference numerals are used to indicate the same or similar elements.

Hereinafter, an electronic caddie-type golf assistance system based on weather information calculated by inputting real-time weather measurement values into a high-precision weather modeling according to some embodiments of the present disclosure will be described in detail with reference to the accompanying drawings.

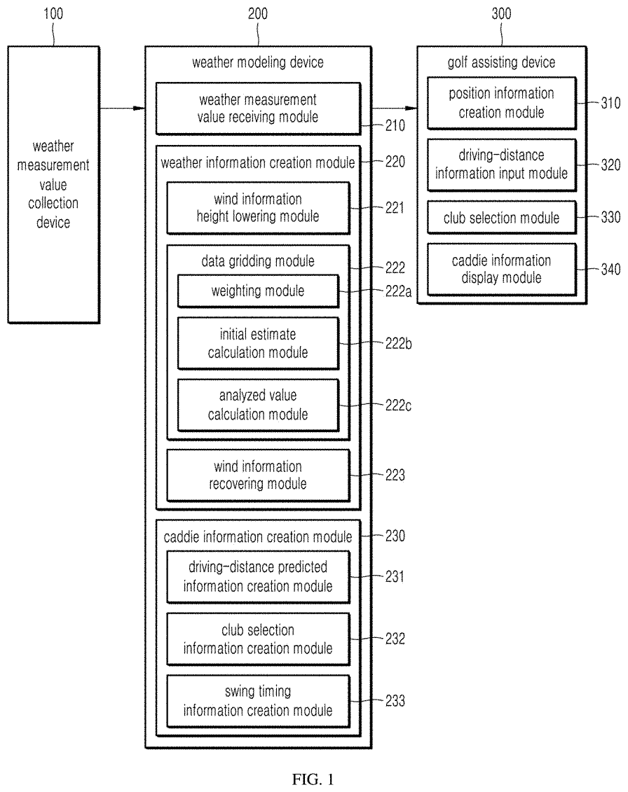

FIG. 1 is a block diagram of an electronic caddie-type golf assistance system based on weather information calculated by inputting real-time weather measurement values into a high-precision weather modeling according to the present disclosure.

As shown in FIG. 1, the electronic caddie-type golf assistance system based on weather information calculated by inputting real-time weather measurement values into a high-precision weather modeling according to the present disclosure includes a weather measurement value collection device 100 that collects weather measurement values of a golf course, a weather modeling device 200 that calculates weather information based on the collected weather measurement values, and a golf assisting device 300 that receives and displays the weather information calculated from the weather modeling device 200.

The weather measurement value collection device 100 may be configured for collecting weather measurement values used for calculating weather information of a golf course, and may include a plurality of weather measurement value collection devices which may be installed in 8 directions or 4 directions along an outside of the golf course. The weather measurement value collection device 100 may be installed at a pole-type tower having a length of 30 to 40 meters. However, the present disclosure is not limited thereto. The weather measurement value collection devices 100 may be arranged to be spaced from each other by approximately 10 meters and may be installed on existing facilities such as a lighting tower or a golf tournament relay tower that is already installed without using the above-described pole-type tower. The weather measurement value collection device 100 installed in this way collects weather measurement values including aa location, a temperature, a wind direction, a wind speed, and a height. In addition, in this embodiment, the weather measurement value collection device 100 may include the Internet of Things (IoT) or a beacon, a wire drone weather sensor. The weather measurement value collection devices 100 may be installed at an optimum observation point of the golf course based on scalability and maintenance efficiency and at an optimum observation density based on height-based observation factors.

The weather modeling device 200 calculates weather information using the weather measurement value collected from the weather measurement value collection device 100 as an input value. To this end, the weather modeling device 200 includes a weather measurement value receiving module 210 that receives the weather measurement value collected from the weather measurement value collection device 100, a weather information creation module 220 which creates weather information based on the received weather measurement value from the weather measurement value receiving module 210; and a caddie information creation module 230 that creates caddie information including driving-distance predicted information and club selection information based on the weather information created in the weather information creation module 220.

The weather measurement value receiving module 210 receives the weather measurement value collected from the weather measurement value collection device 100. This weather measurement value receiving module 210 may be embodied as a communication module. Furthermore, the above-described weather measurement value collection device 100 may be provided with a communication module for transmitting the collected weather measurement value to the weather modeling device 200. The golf assisting device 300 to be described later may also be provided with a communication module.

The weather information creation module 220 creates weather information based on the weather measurement value received from the weather measurement value receiving module 210. In this connection, the weather measurement value includes a temperature, a humidity, a wind direction, a wind speed, and an air pressure, and includes a position where the temperature, the humidity, the wind direction, the wind speed, and the air pressure are measured. This weather information creation module 220 includes a wind information height lowering module 221 that lowers wind data observed in the weather measurement value collection device 100 to a sea level pressure using higher level data, a data gridding module 222 for gridding irregular data into gridded data, and a wind information recovering module 223 for inputting gridded data as initial data of a quantitative wind diagnosis model to raise the level to a detailed topographical height of a target area to recover wind information.

The wind information height lowering module 221 lowers the wind data observed in each weather measurement value collection device 100 to the sea level pressure using higher level data, that is, lowers the height to the sea level pressure. In accordance with the present disclosure, the height is lowered such that the heights of the different weather measurement value collection devices 100 are equal to each other and, accordingly, wind information observed in the weather measurement value collection device 100 varies. In this connection, the present disclosure uses reanalysis data in addition to the data observed from the weather measurement value collection device 100 to lower or raise the level related to the wind information. The reanalysis data may include geopotential height (m), eastward wind (m/s) and northward wind (m/s).

The data gridding module 222 may grid the observed wind data lowered to the sea level pressure by the wind information height lowering module 221, that is, AWS (Automatic Weather System), ASOS (Automated Synoptic Observing System) data having an irregular shape lowered to the sea level pressure in a griding manner shown in FIG. 6 to fit the quantitative wind diagnostic model. According to the present disclosure, the Barnes objective analysis method is used as an interpolation method for gridding. the Barnes objective analysis method imposes a wight according to a distance from a grid point to a value of the observation point around the grid point, and thus calculates the values of uniform grid points from the values of the observation points that are randomly distributed. In addition, accordingly, the gridding module includes a weighting module 222a, an initial estimate calculation module 222b, and an analyzed value calculation module 222c.

The weighting module 222a obtains a weight according to the distance of the observation point around the grid point to the grid point.

When the weighting module 222a determines the weight according to the distance between the observation point and the grid point within a influence radius, the initial estimate calculation module 222b calculates an initial estimate at each grid point using an initial value at each observation point.

The analyzed value calculation module 222c may perform interpolation from the initial estimates at the grid points within the influence radius around the observation point to calculate the analyzed value at the observation point. Then, the analyzed value calculation module 222c may impose the weight according to the distance to a difference between the initial value at the observation point and the analyzed value, and then obtain an analyzed value at a desired grid point.

The wind information recovering module 223 recovers wind information in the target area. To this end, the wind information recovering module 223 includes a wind information height raising module. In addition, the wind information recovering module 223 to be described later acts as a practical quantitative wind diagnostic model according to the present disclosure.

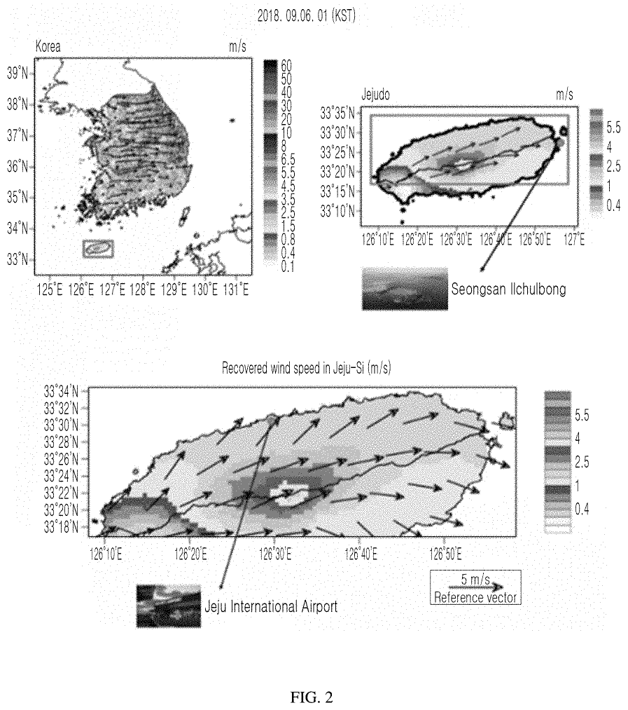

FIG. 2 is an example of recovered Jejudo wind and precipitation at 1 km resolution in an electronic caddie-type golf assistance system based on weather information calculated by inputting real-time weather measurement values into a high-precision weather modeling according to the present disclosure.

The wind information height raising module raises the recovered wind information from the wind information recovering module 223, that is, the sea level pressure wind data interpolated to the desired grid size, to a detailed geographical height, that is, an actual height of an area whose wind information is to be recovered. This is intended to recover wind information in an area in which wind information is not observed using the observed data substantially observed in the first weather measurement value collection device 100 and the second weather measurement value collection device 100. Because the height has been lowered such that the heights of the first weather measurement value collection device 100 and the second weather measurement value collection device 100 are equal to each other, the height of the area in which the wind information is not observed has been also lowered. Therefore, in order to accurately recover the wind information about the unobserved area, the unobserved area is raised to the actual height, that is, the detailed geographical height. Further, accordingly, the wind information may be recovered as shown in FIG. 2. FIG. 2 shows recovery of the wind information at 1 km resolution. The present disclosure may calculate a local-scale detailed wind field of 1 m to 30 m. In addition, in order to increase the resolution of the detailed wind field on the local scale, it is preferable to calculate a high-precision GIS with a drone and use the same as an input value to the weather modeling device 200. The wind information creation configuration as described above is only an example. The present disclosure may create the wind information in various ways.

The caddie information creation module 230 creates caddie information based on the weather information created in the weather information creation module 220. In this connection, the caddie information includes wind information, driving-distance information, club selection information, and swing timing information. To create the caddie information, the caddie information creation module 230 includes a driving-distance predicted information creation module 231, a club selection information creation module 232, and a swing timing information creation module 233. In this connection, wind information includes the wind information recovered in the weather information creation module 220 as described above.

The driving-distance predicted information creation module 231 creates driving-distance predicted information based on the user's club-specific driving-distance information received by a driving-distance information input module 320 of a wind direction and speed and golf assisting device 300. This information may be created by applying the wind direction and wind speed to the driving-distance information of a currently selected club. For example, when the currently selected club is a #7-iron and the driving-distance information about the #7-iron is 150 yards, 150 yards will be the driving-distance predicted information under no wind. In this connection, under headwind, the driving-distance predicted information decreases. The stronger the strength of the headwind, the more the decrease in the driving-distance predicted information. Further, under tail wind, the driving-distance predicted information increases. The stronger the strength of the tail wind, the more the increase in the driving-distance predicted information. The driving-distance predicted information creation module 231 may also create the driving-distance predicted information based on the wind direction and wind speed according to the height.

The club selection information creation module 232 creates club selection information to be presented to the user based on the driving-distance predicted information created in the driving-distance predicted information creation module 231. For example, when the distance to the hole is 130 yards and the headwind is weak, the module 232 may create club selection information having an 8 iron as a club whose driving-distance predicted information is 130 yards. It is meaningless to create the club selection information when the wind changes rapidly. It is preferable for the club selection information creation module 232 to create the club selection information when wind direction changes and wind speed changes are within a predetermined range.

The swing timing information creation module 233 creates swing timing information based on the wind information included in the caddie information. In this connection, the swing timing information creation may be created by determining, as the swing timing, a time when wind is not present, or when the wind blows at a wind speed within a predetermined range which is close to no wind. However, the present disclosure is not limited thereto. For example, the swing timing may be input from the user. This may be, for example, the case when there is no wind or a when the wind blows at a wind speed within a predetermined range which is close to no wind, as described above. Further, this may be the case when the headwind or a tail wind blows while the player is facing toward the hole. It is preferable that as soon as the swing timing information creation module 233 has created the swing timing information, the module 233 immediately transmits the swing timing information to the golf assisting device 30, and the golf assisting device 300 displays the same immediately. In this connection, when the player performs swinging using a sand wedge, the ball's trajectory is high. When the player performs swinging using an iron, the ball's trajectory is lower than that when using the sand wedge. Therefore, when a user swings with the sand wedge, the swing timing information creation module 233 may create the swing timing information based on a wind of a height above a certain height. When the user performs swinging with the iron, the swing timing information creation module 233 may create the swing timing information based on a wind of a height below a certain height. The swing timing information creation module 233 may automatically create the swing timing information based on the wind information in a certain height range according to the club selected by the user. The aforementioned predetermined height range may be manually changed by the user. This is because, for example, even when the user use the iron, the user may shoot the ball along a high trajectory.

The golf assisting device 300 provides the user with the caddie information created in the weather modeling device 200. The golf assisting device 300 may be implemented in various forms such as a wrist watch type, a telescope type, a smartphone type, and an attachment type. In addition, the golf assisting device 300 includes a position information creation module 310 that creates position information, and a driving-distance information input module 320 that receives club-specific driving-distance information from a user, a club selection module 330 which receives a currently-to-be-used club from the user, and a caddie information display module 340 which displays the caddie information created in the weather modeling device 200.

The position information creation module 310 creates position information using the GNSS (Global Navigation Satellite System). Generally, the golf assisting device 300 is being carried on the user. The position information creation module 310 creates the user's position information by creating the position information of the golf assisting device 300. Further, the position information creation module 310 transmits the created position information to the weather modeling device 200.

The driving-distance information input module 320 receives club-specific driving-distance information from the user. That is, the user inputs his/her club-specific driving-distance information using a touch screen or a button provided in the golf assisting device 300.

The club selection module 330 receives the currently-to-be-used club input from the user. That is, the user selects a club to be currently used, using a touch screen or a button. The selected club may be used to create the caddie information.

The caddie information display module 340 displays the caddie information created in the weather modeling device 200. To this end, the caddie information display module 340 may display the caddie information visually via a display or present the information in an audio manner via a speaker. The indication of the swing timing may also be presented to the user via vibration.

In one example, the golf assisting device 300 according to the present disclosure may be recognized by the weather modeling device 200 when the golf assisting device 300 is located in an information provision range, that is, within a predetermined range from the weather measurement value collection device 100. In this connection, the recognition of the golf assisting device 300 may be performed based on a unique number corresponding to each golf assisting device 300. The present disclosure is not limited thereto. The weather modeling device 200 receives and authenticates user information from the user, for example, the unique number corresponding to the golf assisting device 300, and then registers a ID and a password received from the user. The golf assisting device 300 may send the ID and password input from the user to the weather modeling device 200 such that the ID and password is authenticated by the device 200.

As described above, the present disclosure may provide local-scale three-dimensional wind information on a golf course to improve golfing performance of the user.

As described above, the present disclosure has been described with reference to the illustrated drawings, but the present disclosure is not limited by the embodiments and drawings disclosed in the present specification. It is obvious that various modifications may be made by those skilled in the art within the scope of the technical idea of the present disclosure. In addition, even when effects according to the configuration of the present disclosure is not explicitly described while describing the embodiment of the present disclosure, it is natural that the effects predicted from the configuration should also be recognized.

1. A golf assistance system comprising:
a weather measurement value collection device configured to acquire weather information on a golf course;
a weather modeling device configured to model the weather information acquired from the weather information acquiring device to recover wind information; and
a golf assisting device configured to present caddie information based on the recovered wind information.

2. The system of claim 1, wherein the weather measurement value collection device includes a plurality of weather measurement value collection devices arranged in 8 directions or 4 directions along a perimeter of the golf course.

3. The system of claim 2, wherein the golf assisting device includes:
a position information creation module configured to create position information;
a driving-distance information input module configured to receive club-specific driving-distance information from a user;
a club selection module configured to receive a currently-to-be-used club from the user; and
a caddie information display module configured to display the caddie information based on the recovered wind information from the weather modeling device.

4. The system of claim 3, wherein the weather modeling device includes a caddie information creation module,
wherein the caddie information creation module includes:
a driving-distance predicted information creation module configured to create driving-distance predicted information based on a wind direction and a wind speed included in the wind information, and the club-specific driving-distance information received by the driving-distance information input module; and
a club selection information creation module configured to select a club corresponding to the driving-distance predicted information created by the driving-distance predicted information creation module to create club selection information.

5. The system of claim 4, wherein the caddie information includes the wind information recovered by the weather modeling device, the driving-distance predicted information, and the club selection information.
